(19) United States
(12) Patent Application Publication
(10) Pub. No.: US 2003/0076631 A1
(43) Pub. Date: Apr. 24, 2003

(54) Tape head assembly with drop-in transducer block

(75) Inventors: Joseph Edward Torline, Arvada, CO (US); Lee Jaderborg, Frederick, CO (US)

Correspondence Address: Timothy R. Schulte, Storage Technology Corporation, One StorageTek Drive, MS-4309, Louisville, CO, 80028-4309, US

(73) Assignee: Storage Technology Corporation, Louisville, CO

(21) Appl. No.: 10/011,372

(22) Filed: Oct. 22, 2001

(51) Int. Cl. G11B 5/10

(52) U.S. Cl. 360/129

(57) ABSTRACT

A transducer assembly and a method for manufacturing same, the assembly for use in a transducer head, the transducer head for use in a data storage system including a magnetic medium. The assembly includes a transducer portion made from a material having a material property, and a cover portion made from a material having a material property substantially similar to the material property of the material of the transducer portion. The assembly further includes a single piece base portion made from a moldable material, the base portion including features for positioning the cover portion in proximity to the transducer portion so that the cover and transducer portions provide a surface for contacting the magnetic medium.

### TECHNICAL FIELD

The present invention relates generally to a tape head assembly with a drop-in transducer block and, more particularly, to a tape head assembly with a drop-in transducer block and a moldable base that includes features to facilitate construction of the assembly and its incorporation into a tape head.

### BACKGROUND ART

Transducers for use in reading or writing data to a magnetic medium, such as magnetic tape, in data storage systems are typically manufactured on substrates using thin-film processes similar to those used in the semiconductor industry. In that regard, a number of transducers are fabricated on a substrate in groupings or blocks that compose a module for use in a tape head. Several modules are typically fabricated out of a given substrate, which may also be referred to as a wafer.

Once the fabrication of the transducers is completed, diamond slicing processes are used for cutting the wafer in order to separate the individual modules from each other, and a coverplate is attached to each module. The coverplate acts to protect the transducers during subsequent machining and assembly processes, and also ultimately composes part of the interface between the magnetic tape and the tape head. In that regard, machining processes such as lapping and/or grinding are used to provide the transducer and coverplate with a rounded or substantially cylindrical contour surface for interfacing with the tape.

The coverplate and transducer module together form a subassembly, which may be used alone or combined with one or more similar subassemblies in a back-to-back fashion to compose a thin-film tape head. Each transducer in the module also requires a pair of electrical connections to receive power in order to read or write data to the magnetic tape. Such electrical connections are typically provided by a flat, flexible cable carrying a number of electrical conductors which are attached to the transducer module.

Traditionally, the physical space required on the substrate for a group of transducers that compose a module has been very similar to the physical dimensions required for the tape head. Thus, the criteria for spacing the modules on the substrate has been based on the length of the tape head, and the subassembly is composed of half substrate material and half coverplate material. With such a configuration of the tape head, the number of tracks of data that can be placed on the tape correspond to the number of transducers in the module.

However, increasingly large amounts of data are being handled in data storage and processing systems. To increase the amount of data that can be stored on a given tape, the trend has been to increase the density or number of data tracks on the tape. Due to various physical and manufacturing limitations, however, the number of transducers that can be grouped together in a single module on a substrate is limited. Moreover, if any one transducer in a module is inoperative, such as may result from a manufacturing problem, the entire module is unusable and must be scrapped, thereby decreasing wafer yield. As the number of transducers grouped together in a module increases, the possibility of an inoperative transducer increases as well.

Thus, in order to maintain wafer processing yields and reduce the number of electrical interconnections, the tendency in thin-film tape head design has been to minimize the number of transducers per tape head. Higher data track densities are then achieved on the tape by moving the head across the width of the tape laterally during read or write operations, rather than having the head remain stationary. Such servo techniques can lead to tape head designs where the physical space required on the substrate for a group of transducers that compose a module is a fraction of the physical dimensions required for the tape head. In that regard, for magnetic tapes having widths on the order of 0.5 inch, a tape head may require a width on the order of 1 inch to allow the tape head to servo across the width of the tape while maintaining adequate support for the tape. The transducers that compose a module in the tape head, however, may be grouped together in an area on the order of 0.200 inch wide.

However, the cost per substrate associated with fabricating thin-film transducers is substantially the same regardless of the number of transducers fabricated. As a result, it is desirable to maximize the number of modules fabricated per substrate. This dictates that the modules be spaced together on the substrate as densely as possible. Once separated from each other, these smaller transducer modules must then be combined with blocks of bulk material in order to form a subassembly with the physical dimensions needed for the tape head. These subassemblies, once again, may be used alone or combined with other subassemblies to form a tape head. This type of tape head assembly is commonly referred to by those of ordinary skill as a “drop-in” assembly.

Prior art drop-in assemblies include a pair of relatively inexpensive bulk material blocks that are attached, typically using an epoxy or glue material, to each end of a transducer module. Thereafter, a relatively inexpensive bulk material coverplate is attached to the bulk material blocks and transducer module, again typically using epoxy or glue. The material properties or characteristics of the bulk material blocks and coverplate, such as thermal coefficients of expansion, mechanical wear rates and/or hardness, and other material properties, are typically matched as closely as possible to the material properties of the substrate material of the transducer module. In that regard, the substrate material of the transducer module is typically an aluminum-titanium-carbide (AlTiC) compound. As a result, the bulk material blocks and coverplate are also typically formed from AlTiC, so that the coverplate and transducer module wear similarly as a magnetic tape passes across the head tape interface.

However, because of the number of pieces involved, their sizes and relative shapes, combining the transducer module with the bulk material blocks and coverplate in such prior art drop-in assemblies is a relatively inefficient and expensive process. Still further, for the same reasons, epoxy or glue material can be present at the contoured surface that ultimately interfaces with the magnetic tape, which can cause problems with respect to read and write operation, as well as tape and/or tape head wear.

Thus, there exists a need for an improved drop-in assembly that overcomes the above-described problems while retaining the above-identified benefits. In addition to a transducer portion, such a drop-in assembly would also include a single piece base portion and a cover portion. As it is in the region of the tape head near the transducers, the cover portion would comprise a material having similar material properties to those properties of the substrate material of the transducer portion. In addition, combining the transducer portion with the base portion would be efficient and inexpensive. In that regard, the base portion would comprise a relatively inexpensive moldable material, preferably a ceramic, that would allow for ease of fabrication, and would include means for positioning the cover portion in proximity to the transducer portion so that the cover and transducer portions would provide a surface for interfacing with a magnetic tape.

### SUMMARY OF THE INVENTION

Accordingly, it is an object of the present invention to provide an improved transducer assembly with a drop-in transducer block and a moldable base that includes features to facilitate construction of the assembly and its incorporation into a tape head, and a method for manufacturing same.

According to the present invention, then, a transducer assembly is provided for use in a transducer head, the transducer head for use in a data storage system including a magnetic medium. The assembly comprises a transducer portion comprising a material having a material property, and a cover portion comprising a material having a material property substantially similar to the material property of the material of the transducer portion. The assembly further comprises a single piece base portion comprising a moldable material, the base portion including means for positioning the cover portion in proximity to the transducer portion so that the cover and transducer portions provide a surface for contacting the magnetic medium.

Still further according to the present invention, a method is also provided for manufacturing a transducer assembly for use in a transducer head, the transducer head for use in a data storage system including a magnetic medium. The method comprises providing a transducer portion comprising a material having a material property, and providing a cover portion comprising a material having a material property substantially similar to the material property of the material of the transducer portion. The method further comprises providing a single piece base portion comprising a moldable material, the base portion including means for positioning the cover portion in proximity to the transducer portion so that the cover and transducer portions provide a surface for contacting the magnetic medium.

These and other features and advantages of the present invention are readily apparent from the following detailed description of the present invention when taken in connection with the accompanying drawings.

### BRIEF DESCRIPTION OF THE DRAWINGS

FIG. 1 is a simplified illustration of a substrate or wafer where individual transducer modules have been separated from each other;

FIGS. 2a-c are simplified illustrations of prior art full-size individual transducer modules and coverplates, shown in exploded and assembled perspective views, and a side view;

FIGS. 3a-d are simplified illustrations of prior art drop-in tape head assemblies, shown in exploded and assembled perspective views, and side and top views;

FIGS. 4a-e are simplified illustrations of the improved drop-in assembly according to the present invention, shown in exploded and assembled perspective views, and side and top views; and

FIG. 5 is a simplified, representative flow chart of the method for manufacturing the transducer assembly of the present invention.

### BEST MODE FOR CARRYING OUT THE INVENTION

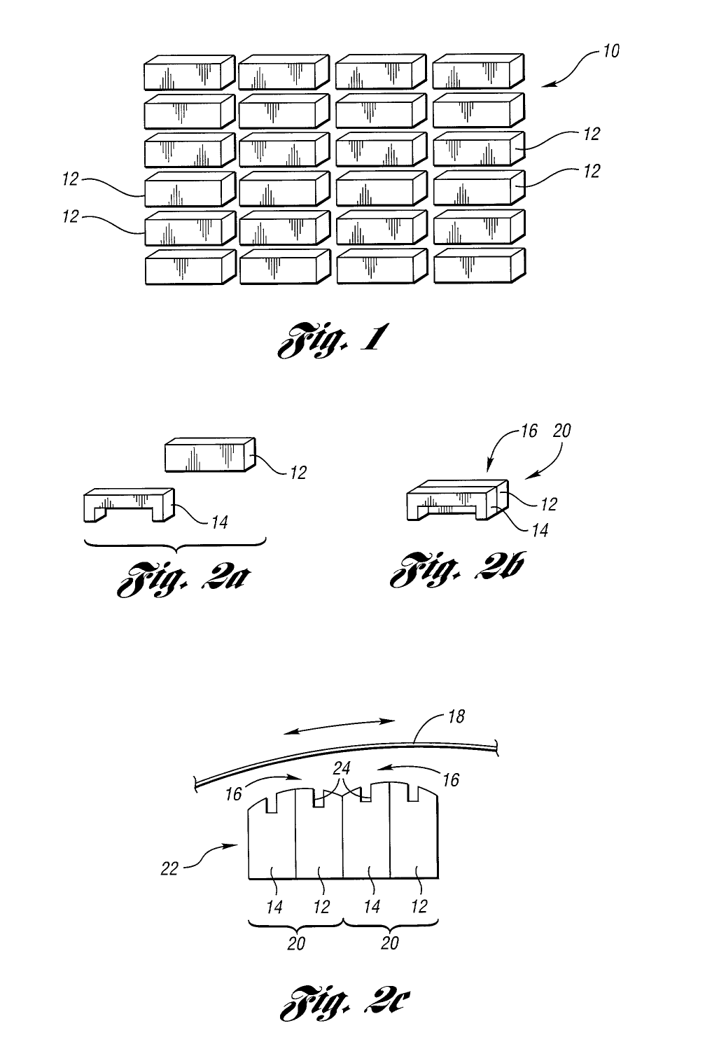

With reference to FIGS. 1-5, the preferred embodiment of the present invention will now be described in greater detail. As previously noted, transducers for use in reading or writing data to a magnetic medium, such as magnetic tape, in data storage systems are typically manufactured on substrates using thin-film processes similar to those used in the semiconductor industry. A number of transducers are fabricated on a substrate in groupings or blocks that compose a module for use in a tape head. Several modules are typically fabricated out of a given substrate, which may also be referred to as a wafer. Once the fabrication of the transducers is completed, diamond slicing processes are used for cutting the wafer in order to separate the individual modules from each other. In that regard, FIG. 1 is a simplified illustration of such a wafer, denoted by reference numeral 10, where the individual modules (12) have been separated from each other. As previously noted, each module (12) includes a plurality of transducers (not shown).

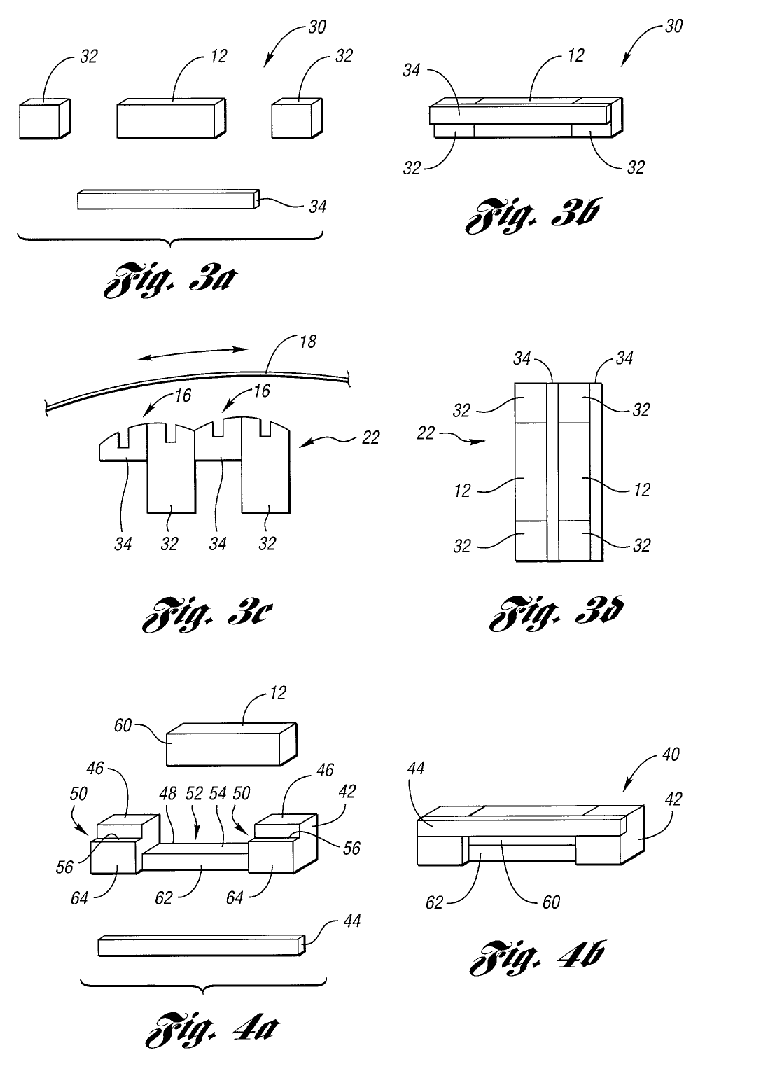

Referring next to FIGS. 2a-c, simplified illustrations of prior art full-size individual transducer modules (12) and coverplates (14) (which may also be referred to as a closure piece or cover portion) are shown in exploded and assembled perspective views, and a side view, respectively. As seen therein, and with continuing reference to FIG. 1, after separation of the individual transducer modules (12) from wafer (10), a coverplate (14) is attached to each module (12). Coverplate (14) acts to protect the transducers on module (12) during subsequent machining and assembly processes, and also ultimately composes part of the interface between the magnetic tape and the tape head. Coverplate (14) and transducer module (12) together form a subassembly (20).

In that regard, as seen in FIG. 2c, machining processes provide the transducer module (12) and coverplate (14) with a substantially cylindrical contour surface (16) for interfacing with a magnetic tape (18). The subassemblies (20) formed by coverplates (14) and modules (12) may be used individually or in combination in back-to-back fashion to compose a thin-film tape head (22). In that regard, FIG. 2c shows what is commonly referred to in the art as a “two bump” tape head (22), where one transducer module (20) may be provided for writing data to tape (18), while the other transducer module (20) may be provided for reading data from tape (18), particularly to verify data immediately after it is written.

As shown in FIG. 2c, and as is well known to those of ordinary skill, to maintain contact between tape (18) and the transducers that are part of subassemblies (20) during read and/or write operations, a number of slots (24) may be formed in subassemblies (20) which serve to bleed off air and catch any debris that may become trapped between tape (18) and subassemblies (20) as tape (18) moves over the head tape interface surfaces (16). Each transducer in each module (12) also requires a pair of electrical connections (not shown) for operation in order to read or write data to the magnetic tape (18) as the tape (18) passes in either direction shown by the arrow in FIG. 2c over tape head (22). Such electrical connections are typically provided by a flat, flexible cable (not shown) carrying a number of electrical conductors which are attached to the transducer module (12).

Traditionally, the physical space required on the substrate for a group of transducers that compose a module (12) has been very similar to the physical dimensions required for the tape head (22). Thus, the criteria for spacing the modules (12) on a wafer (10) has been based on the length of the tape head (22), and the resulting subassemblies (20) are composed of half substrate material and half coverplate (14) material. With such a configuration of the tape head (22), the number of tracks of data that can be placed on the tape (18) correspond to the number of transducers in the module (12).

However, as also previously discussed, increasingly large amounts of data are being handled in data storage and processing systems. To increase the amount of data that can be stored on a given tape (18), the trend has been to increase the density or number of data tracks on the tape (18). Due to various physical and manufacturing limitations, however, the number of transducers that can be grouped together in a single module (12) on a substrate (10) is limited. Moreover, if any one transducer in a module (12) is inoperative, such as may result from a manufacturing problem, the entire module (12) is unusable and must be scrapped, thereby decreasing wafer yield. As the number of transducers grouped together in a module (12) increases, the possibility of an inoperative transducer increases as well.

Thus, in order to maintain wafer processing yields and reduce the number of electrical interconnections required, the tendency in thin-film tape head design has been to minimize the number of transducers per tape head (22). Higher data track densities are then achieved on the tape (18) by moving the head (22) across the width of the tape (18) laterally during read or write operations. Such servo techniques can lead to tape head designs where the physical space required on the substrate for a group of transducers that compose a module (12) is a fraction of the physical dimensions required for the tape head (22).

However, the cost per substrate (10) associated with fabricating thin-film transducers is substantially the same regardless of the number of transducers fabricated. As a result, it is desirable to maximize the number of modules (12) fabricated per substrate (10). This dictates that the modules (12) be spaced together on the substrate (10) as densely as possible. Once separated from each other, these smaller transducer modules (10) must then be combined with blocks of bulk material in order to form a subassembly (20) with the physical dimensions needed for the tape head (22). These subassemblies (20), once again, may be used alone or combined with others to form a tape head (22). This type of tape head (22) is commonly referred to by those of ordinary skill as a “drop-in” assembly.

Referring now to FIGS. 3a-d, prior art drop-in tape head assemblies are shown in exploded and assembled perspective views, and side and top views, respectively, denoted generally by reference numeral (30). As seen therein, such prior art drop-in assemblies (30) include a pair of relatively inexpensive bulk material end blocks (32) that are attached, typically using an epoxy or glue material (not shown), to each end of a transducer module (12). Thereafter, a relatively inexpensive bulk material coverplate (34) is attached to the bulk material end blocks (32) and transducer module (12), again typically using epoxy or glue (not shown). The material properties of the bulk material end blocks (32) and coverplate (34), such as thermal coefficients of expansion, mechanical wear rate and/or hardness, and other material properties, are typically matched as closely as possible to the material properties of the substrate material of the transducer module (12). It should be noted that FIG. 3c again shows what is commonly referred to in the art as a “two bump” tape head (22) such as described above in connection with FIG. 2c.

However, because of the number of pieces involved, their sizes and relative shapes, the process for combining the transducer module (12) with the bulk material end blocks (32) and coverplate (34) in such prior art drop-in assemblies (30) is relatively inefficient and expensive. In that regard, the four piece construction can be complicated, and results in more potential failure points. The relatively small pieces can also be difficult to handle. Further, the pieces include no features to aid in machining or assembly. Still further, epoxy or glue material (not shown) used on the surfaces of transducer module (12), end blocks (32) and coverplate (34) to attach same to each other can end up being present at the contoured surfaces (16) that ultimately interfaces with the magnetic tape (18), which can cause problems with respect to read and write operation, as well as tape and/or tape head wear.

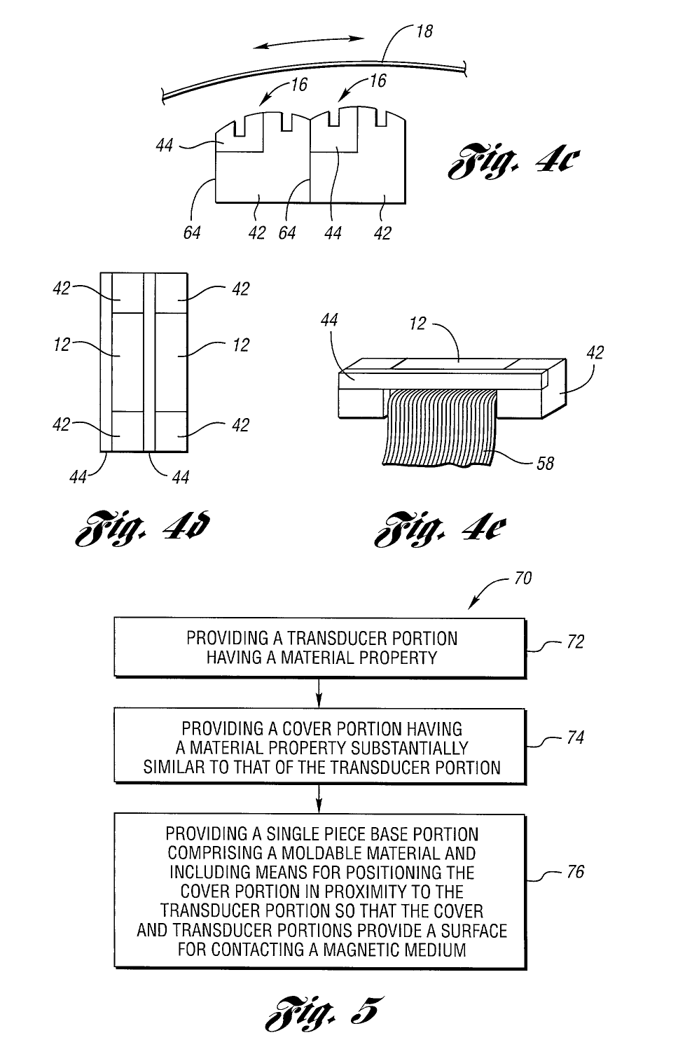

Thus, as noted above, there exists a need for an improved drop-in assembly that overcomes the above-described problems while retaining the above-identified benefits. Referring next to FIGS. 4a-e, simplified illustrations of such an improved drop-in assembly according to the present invention are shown in exploded and assembled perspective views, and side and top views, denoted generally by reference numeral 40. As seen therein, assembly (40) comprises a transducer portion (12) similar to those used in the prior art drop-in assemblies discussed above in connection with FIGS. 3a-d. In addition, assembly (40) also includes a single piece base portion (42) and a cover portion (44). As it is in the region of the tape head (46) near the transducers, cover portion (44) comprises a material having similar material properties to those properties of the substrate material of transducer portion (12), such as thermal coefficient of expansion, and wear resistance and/or hardness. Thus, if the substrate material of transducer portion (12) comprises AlTiC, the same material would preferably be used for cover portion (44).

According to the present invention, combining the transducer portion (12) with the base portion (42) is also efficient and inexpensive. In that regard, base portion (42) comprises a relatively inexpensive moldable material, preferably a ceramic, that allows for ease of fabrication. Further, base portion (42) also includes means for positioning cover portion (44) in proximity to transducer portion (12) so that the cover and transducer portions (44, 12) provide a surface (16) for interfacing with a magnetic tape (18).

More particularly, as seen best in FIG. 4a, base portion (42) preferably includes a pair of end sections (46) and an intermediate section (48) disposed therebetween. In that regard, as noted above, base portion (42) comprises a moldable material, preferably a ceramic such as aluminum oxide or zirconium oxide, so that end sections (46) and intermediate section (48) can be molded as a single, integral piece base portion (42), thereby facilitating relatively simple, low cost, easy manufacture. The moldable material comprising base portion (42) may, like cover portion (44), have similar material properties to those properties of the substrate material of transducer portion (12), such as thermal coefficient of expansion, and wear resistance and/or hardness. However, exactly matching the material properties of base portion (42) to transducer portion (12) is not required.

Still referring to base portion (42), the means for positioning cover portion (44) adjacent transducer portion (12) comprises a first notch-like, slot-like or channel-like area (50) formed across end sections (46) of base portion (42) for receiving cover portion (44), as well as a second notch-like, slot-like or channel-like area (52) formed in base portion (42) by end sections (46) and intermediate section (48) for receiving transducer portion (12). As a result of such a configuration, and in contrast to prior art drop-in assemblies such as discussed above in connection with FIGS. 3a-d, epoxy or glue material (not shown) can be used on surface (54) of base portion (42) for attaching transducer portion (12), and on surfaces (56) of base portion (42) for attaching cover portion (44). Moreover, the reduced, three-piece nature of the assembly (40) also lowers cost, makes construction less complicated, reduces the number of potential failure points, and reduces the amount of epoxy or glue necessary, which can reduce the amount of epoxy or glue present on the contoured surfaces (16) that ultimately interfaces with a tape (18).

Referring still to FIGS. 4a-e, base portion (42) also preferably comprises means for facilitating connections between a plurality of electrical conductors (not shown) carried by a flat, flexible cable (58) and transducer portion (12). In that regard, as is well known to those of ordinary skill, transducer portion (12) includes a face or surface (60) for use in connecting the plurality of electrical conductors to each of the plurality of transducers (not shown) that compose transducer module (12). The means for facilitating connections between the plurality of conductors carried by flex cable (58) and transducer portion (12) comprises a face or surface (62) formed in base portion (42) which, upon attachment of transducer portion (12) and base portion (42), substantially aligns with face or surface (60) of transducer portion (12), thereby providing an attachment or bonding point for flex cable (58), which point can be made as large as necessary for such attachment and is not provided in prior art full size or drop-in assemblies.

Still further, base portion (42) also preferably includes means for facilitating construction of assembly (40) with one or more similar assemblies (40) to create a tape head (22), as seen in FIGS. 4c-d. In that regard, the means for facilitating such assembly comprise faces or ground surfaces (64) formed in base portion (42) which can be made sufficiently large to provide improved stability and support, in contrast to prior art drop-in assemblies, for attachment of another similar assembly (40), again as depicted in FIGS. 4c-d. Epoxy or glue material (not shown) can be used on surfaces (64) for such attachment of assembly (40). It should be noted that FIG. 4c again shows what is commonly referred to in the art as a “two bump” tape head (22). It should also be noted that the block-like nature of base portion (42) depicted in FIGS. 4a-e is not necessary. Indeed, as those of ordinary skill will appreciate, to reduce molding and/or any secondary machining costs, base portion (42) would preferably be designed and molded with more rounded, smoother contours.

Referring finally to FIG. 5, a simplified flowchart depicting the method of the present invention is shown, denoted generally by reference numeral 70. As previously discussed, the method (70) is for manufacturing a transducer assembly for use in a transducer head, the transducer head for use in a data storage system including a magnetic medium. As seen in FIG. 5, the method comprises providing (72) a transducer portion comprising a material having a hardness, and providing (74) a cover portion comprising a material having a hardness substantially equal to the hardness of the material of the transducer portion. The method further comprises providing (76) a single piece base portion comprising a moldable material, the base portion including means for positioning the cover portion in proximity to the transducer portion so that the cover and transducer portions provide a surface for contacting the magnetic medium.

As described in detail above, the base portion comprises a moldable material, preferably a ceramic, that allows for ease of fabrication, and that preferably has material properties similar to those of the material forming the transducer portion. Further, the base portion also includes means for positioning the cover portion in proximity to the transducer portion so that the cover and transducer portions provide a surface for interfacing with a magnetic tape. The base portion also preferably comprises means for facilitating connections between a plurality of electrical conductors carried by a flex cable the transducer portion. Still further, the base portion also preferably includes means for facilitating attachment the assembly to one or more similar assemblies to create a tape head.

It should be noted that the simplified flowchart depicted in FIG. 5 is but an exemplary embodiment of the method of the present invention. In that regard, the steps of such method may be executed in sequences other than those shown in FIG. 5, including the execution of one or more steps simultaneously. It should also be noted that while described herein as a transducer assembly for use in tape head which operates with a magnetic tape medium, the transducer assembly of the present invention may also be used in any other transducer head, such as a disk head which operates with a magnetic disk medium.

As is readily apparent from the foregoing description, the present invention provides an improved drop-in assembly that, in addition to a transducer portion, also includes a single piece base portion and a cover portion. As it is in the region of the tape head near the transducers, the cover portion comprises a material having similar material properties to those properties of the substrate material of the transducer portion. In addition, combining the transducer portion with the base portion is efficient and inexpensive. In that regard, the base portion comprises a relatively inexpensive moldable material, preferably a ceramic, that allows for ease of fabrication, and includes means for positioning the cover portion in proximity to the transducer portion so that the cover and transducer portions provide a surface for interfacing with a magnetic tape. Still further, as a result, minimal epoxy or glue material is present at the contoured surface that ultimately interfaces with the tape.

Thus it is apparent that there has been provided, in accordance with the present invention, an improved transducer assembly with a drop-in transducer block and a moldable base that includes features to facilitate construction and incorporation into a tape head, and a method for manufacturing same. While the present invention has been described in conjunction with specific embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

What is claimed is:

1. A transducer assembly for use in a transducer head, the transducer head for use in a data storage system including a magnetic medium, the assembly comprising:
a transducer portion comprising a material having a material property;
a cover portion comprising a material having a material property substantially similar to the material property of the material of the transducer portion; and
a single piece base portion comprising a moldable material, the base portion including means for positioning the cover portion in proximity to the transducer portion so that the cover and transducer portions provide a surface for contacting the magnetic medium.

2. The assembly of claim 1 wherein the moldable material of the base portion is a ceramic.

3. The assembly of claim 2 wherein the moldable material of the base portion has a material property substantially similar to the material property of the material of the transducer portion.

4. The assembly of claim 1 wherein the means for positioning the cover portion adjacent the transducer portion comprises a first channel-like area formed in the base portion for receiving the cover portion and a second channel-like area formed in the base portion for receiving the transducer portion.

5. The assembly of claim 2 wherein the means for positioning the cover portion adjacent the transducer portion comprises a first channel-like area formed in the base portion for receiving the cover portion and a second channel-like area formed in the base portion for receiving the transducer portion.

6. The assembly of claim 1 wherein the base portion further includes means for facilitating connections between a plurality of electrical conductors and the transducer portion.

7. The assembly of claim 6 wherein the transducer portion includes a face for use in connecting the plurality of conductors, and the means for facilitating connections comprises a face formed in the base portion for substantial alignment with the transducer portion face.

8. The assembly of claim 2 wherein the base portion further includes means for facilitating connections between a plurality of electrical conductors and the transducer portion.

9. The assembly of claim 8 wherein the transducer portion includes a face for use in connecting the plurality of conductors, and the means for facilitating connections comprises a face formed in the base portion for substantial alignment with the transducer portion face.

10. The assembly of claim 5 wherein the base portion further includes means for facilitating connections between a plurality of electrical conductors and the transducer portion.

11. The assembly of claim 10 wherein the transducer portion includes a face for use in connecting the plurality of conductors, and the means for facilitating connections comprises a face formed in the base portion for substantial alignment with the transducer portion face.

12. The assembly of claim 11 wherein the magnetic medium comprises a tape.

13. The assembly of claim 11 wherein the assembly is combined with at least one other similar assembly to produce the transducer head.

14. A method for manufacturing a transducer assembly for use in a transducer head, the transducer head for use in a data storage system including a magnetic medium, the method comprising:
providing a transducer portion comprising a material having a material property;
providing a cover portion comprising a material having a material property substantially similar to the material property of the material of the transducer portion; and
providing a single piece base portion comprising a moldable material, the base portion including means for positioning the cover portion in proximity to the transducer portion so that the cover and transducer portions provide a surface for contacting the magnetic medium.

15. The method of claim 14 wherein the moldable material of the base portion is a ceramic.

16. The method of claim 15 wherein the means for positioning the cover portion adjacent the transducer portion comprises a first channel-like area formed in the base portion for receiving the cover portion and a second channel-like area formed in the base portion for receiving the transducer portion.

17. The method of claim 16 wherein the base portion further includes means for facilitating connections between a plurality of electrical conductors and the transducer portion.

18. The method of claim 17 wherein the transducer portion includes a face for use in connecting the plurality of conductors, and the means for facilitating connections comprises a face formed in the base portion for substantial alignment with the transducer portion face.

19. The method of claim 18 wherein the magnetic medium comprises a tape.

20. The method of claim 18 wherein the assembly is combined with at least one other similar assembly to produce the transducer head.
